(19) United States
(12) Patent Application Publication
(10) Pub. No.: US 2007/0196535 A1
(43) Pub. Date: Aug. 23, 2007

(54) Wine storing apparatus

(75) Inventor: Marco Francia, Casale Monferrato (Alessandria) (IT)

Correspondence Address: SUGHRUE MION, PLLC, 2100 PENNSYLVANIA AVENUE, N.W., SUITE 800, WASHINGTON, DC, 20037, US

(73) Assignee: GIMAR TECNO S.R.L.

(21) Appl. No.: 10/635,614

(22) Filed: Aug. 7, 2003

(30) Foreign Application Priority Data
Aug. 7, 2002 (IT) TO2002A000706

(51) Int. Cl. C12C 11/00

(52) U.S. Cl. 426/11

(57) ABSTRACT

Apparatus for storing wine is described, operable particularly for storage/refinement on the lees of all types of still wine, comprising a reservoir, provided with a rotary doctor blade device and/or blowing devices arranged to act on the surface of the bottom wall of the vessel to prevent sedimentation of the lees and maintain them in suspension; advantageously, the storage apparatus is obtained by adaptation of fermentation apparatus of the type comprising a main vessel and a superimposed upper vessel provided with recycling means which supply the wine withdrawn from the bottom of the main vessel to the interior of the mass of wine contained in this vessel, with the possibility of oxygenation of the mass.

The present invention relates to wine storing apparatus arranged for the conduction, during the storage itself, of automatic operations aimed at maintenance and improvement of the chemical-physical and organoleptic characteristics of the product by means of continued treatment with fine lees (also called storage in the presence of fine lees), such a refinement procedure is known in particular in the vinicultural art with the French language term “elevage sur lie”.

This particular series of procedures, whilst being in the first place put in practice for the refinement of white wines, can, in the judgement of the man skilled in the oenological art, be equally well applied to all types of still wines.

The apparatus forming the subject of the present invention is therefore directed at the automatic execution of this refinement process on all types of still wine.

It is known to those in the art that during the course of storing wine in the presence of fine lees it is necessary to avoid prolonged sedimentation thereof which, by becoming deposited on the bottom of the storage vessel can lead to asphyxiation, causing the generation of malodorous substances with a consequent irreversible deterioration of the aroma of the wine.

It is likewise known that the reintroduction into white wine of coarse lees, previously separated by clarification and decanting, and thereafter separately refined, generates improvement and enrichment effects on the aromatic profile of the product, as long as the said lees are maintained in suspension, avoiding sedimentation.

A first object of the present invention is that of providing apparatus usable for storage/refinement of the wine which makes it possible to maintain the lees in suspension, avoiding sedimentation and avoiding the conventional operations of remixing and manual agitation.

Therefore, the subject of the invention comprises apparatus for the storage/refinement of wine as defined in the following claims.

In one embodiment, the conditioning means comprise a doctor blade device operable to scrape the internal surface of the bottom wall of the vessel to prevent sedimentation of the lees; alternatively, the doctor blade device can be substituted by or integrated with other fixed or movable devices such as, among others, by way of example, those suitable to convey the flow of wine coming from the said recirculation means in a manner such as to effect removal and agitation of the sedimentary layer of lees.

One particularly advantageous embodiment of the invention provides storage apparatus of the above-mentioned type by adaptation and modification of apparatus currently utilised for the fermentation of red wine, which apparatus is therefore normally available at wine making plants.

In particular this concerns fermentation apparatus of the type comprising a main vessel intended to contain the must and an upper vessel, superimposed over the main vessel, and having a lower aperture for the discharge of the fermentation liquid into the main vessel and provided with a shutter movable between an open position and a closure position; such apparatus is moreover provided with recycling means which feed the must from the bottom of the main vessel to the upper vessel and moreover normally include a motorised rotary blade device at the bottom of the main vessel for the extraction of the marc.

Such apparatus is described for example in Italian patents 1 289 672; 1 293 978 and United States patent U.S. Pat. No. 6,279,457, in United States application 802 932 and in Italian patent applications numbers TO2001A000965 and TO2001A001097 in the name of the Applicant.

This involves apparatus of large dimensions and normally high cost, which for the most part operates automatically, being provided with a control unit which allows the user to obtain automated management of the whole of the vinification cycle.

The use of such apparatus is however limited to short seasonal periods for the fermentation of red wine.

At the basis of the invention there is therefore, moreover, the idea of modifying such apparatus for the purpose of extending its use for storage and refinement of wines on the fine lees, by making such apparatus suitable for maintaining the said lees in suspension by preventing sedimentation thereof.

This result can be achieved in an extremely simple and economic manner by providing, at the bottom of the fermentation apparatus, a doctor blade device operable to scrape the internal surface of the bottom wall of the fermentation apparatus and possibly—where necessary—by modifying the recirculation means in such a way as to extract the wine subjected to storage from the bottom of the fermentation apparatus and reintroduce it into an upper zone of the main vessel; if the fermentation apparatus is already provided with motorised blade means for discharge of the marc, the said result can be simply achieved by replacement of the discharge blade with a rotating doctor blade device in contact with the bottom surface, or with a tubular delivery device provided with nozzles or a flat jet device arranged to deliver the flow of recycled wine, or a fraction thereof, towards the bottom of the vessel, possibly associated with a rotating doctor blade.

Further advantages and characteristics of the apparatus according to the invention will become apparent from the following detailed description, given with reference to the annexed drawing, provided by way of non-limitative example, in which:

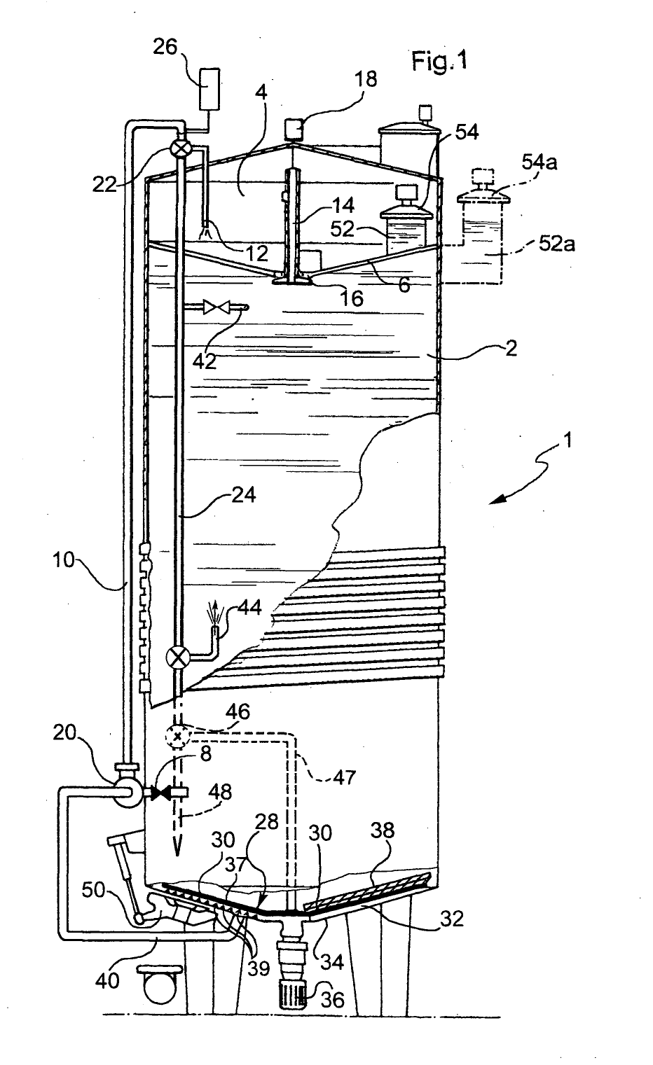

FIG. 1 is a partially sectioned front elevation view of apparatus according to the invention; and

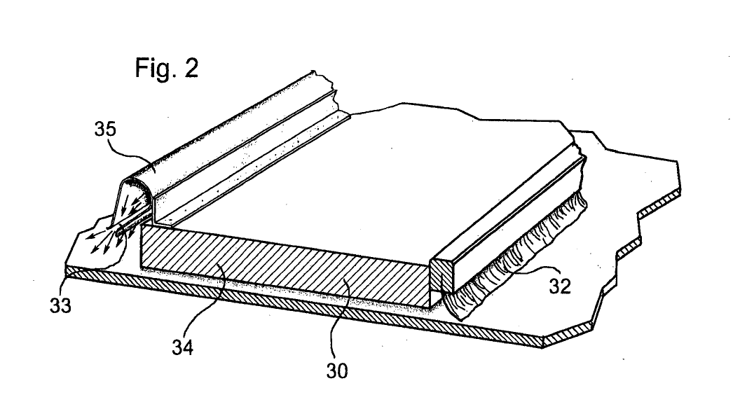

FIG. 2 is a perspective view of a detail of FIG. 1.

The annexed drawing refers to a fermentation vessel arranged to be utilised as apparatus for storage/refinement on the lees according to the invention.

The reference number 1 generally indicates fermentation apparatus of automatically operating type, comprising a main vessel 2 and an upper vessel 4 having a bottom 6 with a central aperture 16 associated with which is a shutter 14 movable between an open position and a closure position of the bottom aperture 16, actuated by an actuator 18.

In operation as fermentation apparatus there are normally provided recycling means 8, 10, 12 and 20, which comprise a duct 8 for withdrawing liquid subject to fermentation from a lower zone of the main vessel and a pump 20 which, via a duct 10, 12 feeds, the liquid into the upper vessel 4.

In this type of operation there can also be provided a duct 24 which reintroduces the liquid into the main vessel, in which case the adoption of a three-way valve 22 is contemplated, which allows the selective supply of the liquid into the upper vessel via the duct 12 or into the main vessel, or into both vessels.

The delivery duct 10 can have oxygenation means associated therewith, in particular an injector 26 provided to inject into the liquid which flows in this duct air suitable to achieve an effective oxygenation.

For further details in relation to the construction characteristics of the fermentation apparatus illustrated reference is made to the content of the previously cited patent documents, and in particular to US patent application 802 932.

As has been mentioned, a particularly advantageous embodiment of the invention contemplates the modification of apparatus of the above-described type for the purpose of extending its use as a vessel for storage and refinement on the lees.

To this end, adjacent to the bottom wall 34 of the main vessel is mounted a doctor blade device 28 provided with one or more rotating arms or blades 30 each with a lip 32, preferably flexible, or a brush which runs in contact with the inner surface of the said bottom wall.

The scraping lip 32 may, for example, be of flexible plastics material; it can be replaced or assisted in its action by other devices such as, for (non-limitative) example, suitable ducts for conveying, for a determined time, the whole or part of the flow of wine generated by the pump 20: the said flow, in particular, can be conveyed by suitable fixed or rotating ducts which are free or fixed to one or more arms provided with one or more outlets of calibrated dimensions adjacent to the doctor blade for causing the lees to be agitated and moved, as an alternative to or in addition to the doctor blade itself.

For example, as schematically shown in FIG. 2, along one longitudinal edge of one or more blades 30, which may be the blade of the marc extractor, can be associated a doctor blade or brush 32 and/or at the other edge there may be a tubular duct 35 provided with a longitudinal outflow aperture 33, for delivery of a laminar jet of the storage liquid towards the bottom of the tank 34, or a plurality of outlet nozzles.

The liquid is supplied to the duct 35, for example, by means of a duct 47 connected to the recirculation duct 24.

Within the scope of the invention is also comprised a device having tubular rotating arms 37 with a plurality of delivery nozzles 39 or with a laminar jet outlet aperture.

For driving the arm or arms 30 to rotate the same motor 36 can be utilised which, in the conventional fermentation apparatus, is utilised for driving the rotating blade member for extraction of the marc. This motor can be arranged for slow rotation of the doctor blade device, for example of the order of 1 to 10 revolutions per minute, sufficient to avoid sedimentation of the lees on the bottom and to maintain them in suspension.

Preferably, there is also provided a static scraper member 38, mounted above the rotating arm 30, for cleaning the arm, in particular the flat surfaces thereof, possibly subjected to retention of the sedimented lees.

The bottom wall 34 of the main vessel is preferably a conical or flat surface.

As an alternative to the above-described device, for application to vinification apparatus which may not be provided with a marc extraction device, or on other vessels not provided with recirculation and extraction systems, there may be provided, in addition, specific recirculation apparatus and apparatus for agitation of the bottom deposits, operating in one or more of the above-indicated modes.

The maintenance in suspension of the lees is critical for obtaining a wine of quality following storage/refinement on the lees.

For this reason the apparatus according to the invention preferably includes a duct 40 communicating with the pump 20 which withdraws the liquid subjected to storage from the bottom 34 and supplies it via the duct 10 and 24 to the interior of the stored liquid mass.

The introduction of the liquid can be achieved at different points, for non-limitative example to the upper zone via a duct 42, in and to the intermediate zone via a duct 44. Preferably, a liquid delivery can be provided by means of a duct 46, provided with an aperture having a narrow terminal section 48 adjacent to the door 50 normally present in fermentation apparatus.

The flow emitted from the narrow section 48 is suitable to avoid sedimentation of the lees in the region of the door 50 which may not be in contact with the rotating doctor blade 28.

For use of the apparatus described as storage apparatus it is necessary to provide for complete filling of the main vessel 2, avoiding the presence of air pockets at the top. For this reason, at the bottom wall 6 of the upper vessel 4 is associated a door opening 52, provided with a cover 54 for allowing complete filling of the vessel 2; alternatively, a door opening 52a can be provided with associated cover 54a (illustrated in broken outline), disposed at the upper end of the main vessel 2.

It is intended that in use as storage apparatus the shutter member 14 is brought into the closed position by means of the actuator 18 to avoid the ingress of liquid into the upper vessel 4.

During the course of storage/refinement on the lees intermittent operations of oxygenation of the wine can be provided by the injection of atmospheric oxygen, utilising the apparatus described in Italian patent 1 293 978 or in US patent application 802 932 or possibly by means of direct introduction of oxygen into the ducts 10 or 40; to this end the introduction of oxygen can also be effected by means of a porous candle.

The maintenance of the lees in suspension, as mentioned, provides important benefits for the quality of the wine in terms of its organoleptic properties. Moreover, the addition of sulphur dioxide can be limited thanks to the antioxidant activity of the lees maintained in suspension.

The invention thus makes available to the vinification industry apparatus which avoids laborious manual operations of decanting and agitation. Moreover, since the apparatus can be obtained by means of a simple modification of normally available fermentation apparatus it is possible to obtain the advantages mentioned above with limited costs.

Since fermentation apparatus is moreover normally automatically operated apparatus the operation of which is managed by a command and control unit, such as is described in Italian patent application TO2001A000965, it is possible to arrange this control unit for the management of the storage operations without substantially increasing the general costs of the apparatus.

What is claimed is:

1. Apparatus for the storage of wine, comprising a vessel provided with recycling means operable to withdraw the wine from a bottom region of the storage vessel and to reintroduce it internally to the mass of wine in storage, and conditioning means arranged to maintain in suspension the lees contained in the wine and/or to prevent sedimentation at the bottom of the vessel.

2. Apparatus according to claim 1, wherein the said conditioning means comprise a doctor blade device operable to scrape the inner surface of the bottom wall of the vessel.

3. Apparatus according to claim 2, wherein the said doctor blade device comprises one or more rotating arms provided with a lip or brushe(s) slidable in contact with or close to the bottom of the vessel.

4. Apparatus according to claim 3, comprising a static scraper member mounted above the arm (or arms) of the rotary doctor blade device and operable to clean it or them.

5. Apparatus according to claim 1, wherein the said conditioning means comprise tubular distribution means mounted adjacent to the bottom of the vessel and communicating with the said recirculation means and provided with a plurality of nozzles and/or other efflux means arranged to deliver the wine supplied to the said tubular distribution means from the said recirculation means towards the bottom wall of the vessel.

6. Apparatus according to claims 1 or 5, wherein the said conditioning means comprise a static or rotary distribution device comprising one or more tubular arms extending radially from the central zone of the bottom of the vessel towards the side wall and having a plurality of nozzles and/or other efflux means for delivery of the wine supplied to the said distribution device by the recirculation means.

7. Apparatus according to claim 5, wherein the said tubular distribution means are associated with one or more rotating blades adjacent to the bottom of the vessel.

8. Apparatus according to claim 1, wherein the said conditioning means comprise a doctor blade device in association with tubular distribution means provided with nozzles and/or other efflux means operable to deliver the wine supplied to the said tubular distribution means from the said recirculation means.

9. Apparatus according to claim 1, which is constituted by fermentation apparatus provided with a main vessel intended to constitute the said storage vessel and by an upper vessel, overlying the said main vessel, having a bottom with a central aperture with which is associated a shutter movable between an open position and a closure position closing the bottom aperture and actuated by an actuator.

10. Apparatus according to claim 1, wherein the said recycling means comprise a wine supply duct adjacent the bottom wall of the said vessel.

11. Apparatus according to claim 10, wherein the said recycling means further include a duct for reintroducing the wine into the heart of the mass of wine in storage/refinement on the lees.

12. Apparatus according to claim 9, wherein the bottom of the upper vessel has an associated hatch or door communicating with the main vessel for allowing complete filling of the said main vessel.

13. Apparatus according to claim 9, wherein at the upper end of the main vessel has an associated hatch or door to allow the complete filling of the said main vessel.

14. Apparatus according to claim 9, wherein the said recycling means have associated oxygen blowing means for oxygenation of the wine subject to recycling.

15. Fermentation apparatus of the type comprising a main vessel and an upper vessel having a bottom with a central aperture with which is associated a shutter movable between an open position and a closure position closing the bottom aperture and actuated by an actuator, further comprising a doctor blade device operable to scrape the inner surface of the bottom wall of the said main vessel, and recycling means operable to withdraw the liquid contained in the said main vessel from the bottom of the said vessel and to reintroduce it internally to the mass of liquid contained in the said main vessel.
